(19) United States
(12) Patent Application Publication
(10) Pub. No.: US 2006/0294558 A1
(43) Pub. Date: Dec. 28, 2006

(54) Presentation of information relating to programming

(75) Inventors: Ronald Alan Morris, San Francisco, CA (US); David Sloo, Menlo Park, CA (US); Peter Barrett, San Francisco, CA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/165,927

(22) Filed: Jun. 23, 2005

(51) Int. Cl. H04N 7/173

(52) U.S. Cl. 725/89; 725/88; 725/102

(57) ABSTRACT

A system that includes a content distribution facility coupled to at least one client device for presenting programming via a presentation device having a screen. The system displays on the screen first content having an associated characteristic. In response to an event other than user selection of a program, the system displays a message stored in at least one of the distribution facility and client device. The message includes subject matter corresponding to the characteristic.

### BACKGROUND

For many years, broadcast television has provided a medium through which entities can solicit individuals to purchase products or services. Advertisements provide a viewer with information about the availability of new products, new purchase rates, and other information specific to different products. Additionally, advertisements, whether static banner advertisements displayed on an electronic program guide or video advertisements typically displayed during a broadcast programming event, generate goodwill and product recognition for the company's products or services.

Providers of these advertisements desire to maximize revenue by enticing the viewer to purchase the product or services offered by the provider. While such advertising may sometimes seem bothersome to viewers, the presence of advertising often reduces the cost of the desired services offered by the service provider. For example, many television channels are provided free-of-charge, since revenue from advertising alone is sufficient to provide these channels. On the other hand, some premium channels present no advertisements, but instead achieve adequate incentives for providing the channel by charging the viewers a periodic fee.

An increasingly popular approach to exposing viewers to advertising material is the display of such material in conjunction with elements of and/or in response to operations associated with user interfaces. For example, a branded logo may be displayed in response to trick-mode operation or transition from one channel to another. In current implementations of this approach, however, no effort is made to match the subject matter (e.g., good or service offered) of these advertisements with the subject matter of the currently displayed content. Consequently, the impact that these advertisements have on the viewer is less than optimal. Additionally, because these advertisements typically are displayed as overlaying the viewed program, the program is at least partially obscured.

### SUMMARY

This Summary is provided to generally introduce, in a simplified form, the reader to one or more select concepts described below in the Detailed Description. This Summary is not intended to identify key and/or required features of the claimed subject matter, nor is it intended to be used as an aid in determining the scope of the claimed subject matter.

An embodiment of the present invention provides a system coupled to a display device, such as a television, having a screen. The system displays on the screen a video program having an associated characteristic, such as, for example, a program topic. The system transitions to a trick-mode display of the program. In response to this transition, the system displays on the screen a message that includes subject matter corresponding to the characteristic.

An embodiment of the present invention further provides a system that includes a content distribution facility, such as a cable headend, coupled to at least one client device, such as a set-top box, for presenting programming via a presentation device, such as a television, having a screen. The system displays on the screen content having an associated characteristic. In response to an event other than user selection of a program, the system displays a promotional message stored in the distribution facility and/or client device. The message includes subject matter corresponding to the characteristic.

### BRIEF DESCRIPTION OF THE DRAWINGS

FIG. 1 is a schematic diagram of an illustrative interactive media system in which embodiments of the invention may be implemented;

FIG. 2 is a functional block diagram of user-equipment portions of the illustrative interactive media system of FIG. 1 in which embodiments of the invention may be implemented;

FIG. 3 is a screen display illustrating operational features according to an embodiment of the invention;

FIGS. 4A and 4B are screen displays illustrating operational features according to an alternative embodiment of the invention;

FIG. 5 is a screen display illustrating operational features according to an alternative embodiment of the invention;

FIG. 6 is a screen display illustrating operational features according to an alternative embodiment of the invention;

FIG. 7 is a flow diagram of a method according to an embodiment of the invention;

FIG. 8 is a flow diagram of a method according to an alternative embodiment of the invention; and

FIG. 9 is a flow diagram of a method according to an alternative embodiment of the invention.

### DETAILED DESCRIPTION

Generally described herein, among other things, are methods, implementable in an interactive media system, that enable the selection and display of one or more messages, the subject matter of which is related to a characteristic of content that is currently displayed, or available for display, on a display device. For example, if the content is a television program, a message identifying additional related programming may be selected and displayed overlaying, or otherwise in conjunction with, the program. If the content is a commercial advertisement, a small banner advertisement identifying the advertised product may be displayed in response to the viewer forwarding, via trick-mode operation, through the commercial advertisement. If the content is an informational message, such as a notification of a news headline, a logo identifying the commercial provider of the message may be displayed. As such, a viewer is presented with advertising or other informational messages that are germane to viewed content and thus more likely to influence the viewer.

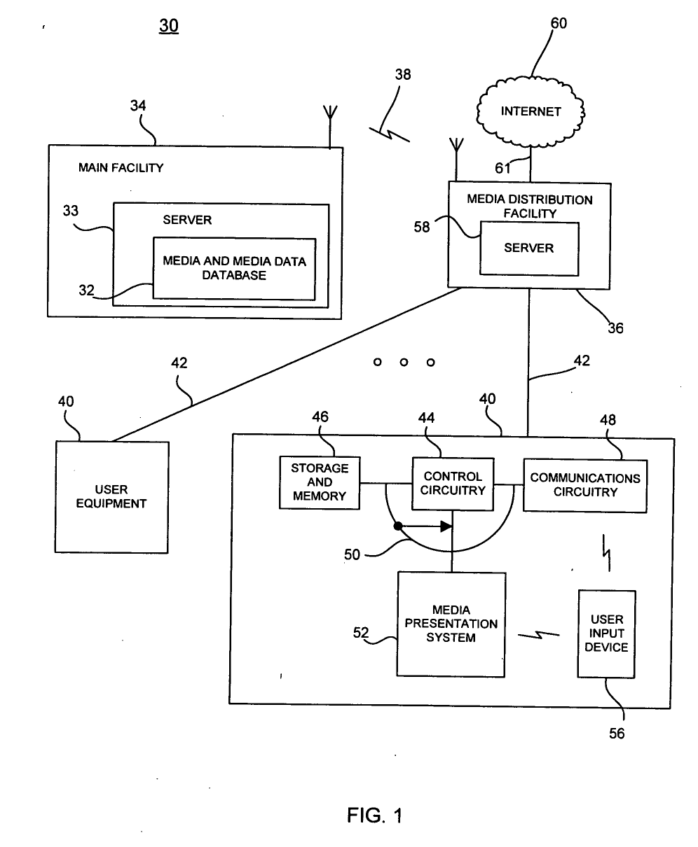

FIG. 1 illustrates an interactive media system 30 in which one or more embodiments of the invention may be implemented. The components of the interactive media system 30 described herein are exemplary and are not intended to suggest any limitation as to the scope of use or functionality of embodiments of the invention. The described embodiments of the invention should not be interpreted as having any particular dependency or requirement relating to any one component or combination of components illustrated in and described with reference to FIG. 1.

The interactive media system 30 may include a main facility 34, a media distribution facility 36, and user equipment 40, including one or more client devices. Although only one main facility 34 is illustrated in FIG. 1, the interactive media system 30 may include multiple main facilities. For clarity, embodiments of the invention will be at least primarily discussed in connection with the use of one such main facility. The main facility 34 may include a server 33 for storing and distributing media programs and associated media data from a media and media data database 32, which may be used for storing media programs and media data.

Media programs may include audio and video media such as broadcast television programs, cable television programs, pay-per-view programs, video-on-demand (VOD) programs, near video-on-demand (NVOD) programs, available-on-demand applications (e.g., on-demand interactive games), music, promotional material, or any other type of deliverable media. In the described exemplary implementations, the media programs may be associated with traditional broadcast channels (which are tuned by frequency), with IPTV broadcast channels (which are tuned by universal resource locator (URL)), and/or with any other types of channels over which media content may be transmitted. Media data may include data associated with the media programs, such as metadata, identifiers, URLs, interactive media application control information, program guide information (e.g., program guide listings data, pay-per-view ordering information, program promotional information, or any other suitable program guide information) or any other deliverable data.

Main facility 34 may distribute the media programs and media data to multiple media distribution facilities 36 via communications paths such as communications path 38. Communications path 38 may be any suitable communications path, such as a satellite link, a cable link, a fiber-optic link, a microwave link, a telephone network link, an Internet link, or a combination of such links. Although only one distribution facility 36 is illustrated in FIG. 1, the interactive media system 30 may include multiple distribution facilities. For clarity, the invention will be primarily discussed in connection with the use of one such distribution facility.

Media distribution facility 36 may be a broadcast television facility, a cable system headend, a satellite distribution facility, a broadcast music facility, or any other suitable media distribution facility for transmitting media programs and any other suitable information to user equipment 40. Media distribution facility 36 may include a server 58. Server 58 may be capable of handling media such as text, images, graphics, audio, video, any other suitable media, or a combination of such media. Server 58 may include a database for storing media programs, media data or any other suitable content. In addition, server 58 may be capable of providing interactive services such as NVOD and VOD. Server 58 may be based on one or more computers. Media distribution facility 36 may distribute various media programs to user equipment 40 over communications paths 42, which may be unidirectional or bidirectional.

Each media distribution facility 36 may have a number of associated users, each of which may have user equipment 40 coupled to the media distribution facility via one of communications paths 42. User equipment 40 may include equipment such as user television equipment, user computer equipment (e.g., a desktop computer, a laptop computer, a notebook computer, a handheld computing device such as a personal digital assistant or other small portable computer, etc.), user music equipment (e.g., a stereo receiver) or any other suitable user media equipment for presenting media programs and/or executing an application, such as an interactive media application. An interactive media application may be implemented locally on user equipment 40 or may be implemented using a client-server or distributed architecture where some of the application is implemented locally on user equipment 40 in the form of a client process and some of the application is implemented at a remote location (e.g., media distribution facility 36) as a server process.

User equipment 40 may include components, such as control circuitry 44, storage and memory 46, communication circuitry 48, media presentation system 52, and user input device 56, for presenting media programs and/or implementing an interactive media application. The control circuitry 44, storage and memory 46, and communication circuitry 48 may be combined to form a conventional client device, such as, for example, a set-top box (STB). The components may be configured to support functions of the interactive media application such as receiving media programs and media data, recording media programs to storage and memory 46, simultaneously recording and playing media programs, playing recorded media programs from storage, and sending and receiving application data and information. Control circuitry 44 may communicate with and control storage and memory 46, communications circuitry 48, and media presentation system 52 using communications paths 50. Paths 50 may be hard-wired, wireless (e.g., Bluetooth), optical paths or the like.

Storage and memory 46 may include a magnetic media recorder (e.g., hard disk drive or the like), memory (e.g. flash memory, EEPROM, or the like), a videocassette recorder, a digital recording device, any other suitable memory and storage device, or any suitable combination thereof. Some or all of storage and memory 46 may be located external to a device that contains control circuitry 44.

Control circuitry 44 may provide media presentation system 52 with media program content stored in storage and memory 46. Control circuitry 44 may also provide media presentation system 52 with media program content that is received from communications circuitry 48. Media presentation system 52 may include a television, a computer system with monitor and speakers, a stereo system, any other suitable presentation device, or any combination thereof.

The user may interact with control circuitry 44 using input device 56. User input device 56 may include a remote control, a keyboard, a wireless keyboard, display remote, a handheld computer, a mouse, a trackball, a touch pad, or any other suitable interactive interface. User input device 56 may transmit signals to communications circuitry 48 or media presentation system 52 via any suitable communications path, such as a hard-wired or wireless path.

The features of embodiments of the present invention may be described herein in the context of an interactive media application implemented in, for example, software and/or firmware on one or more components of the system 30. This is only illustrative. An interactive media application implemented on any suitable platform (user computer equipment, user music equipment, or any other suitable platform) may be used to provide described features, such as selecting and/or generating to a screen associated with the presentation system 52 informational messages and logos.

In an embodiment, the interactive media application may provide the user with access to real-time media programs. The real-time media programs may, for example, be television programming, music programming, interactive gaming programming or any other suitable media. The real-time media programs may be presented to the user on media presentation system 52. The interactive media application may provide the user with the ability to pause the real-time media programs. This may be done, for example, by pressing a pause button on a remote control. In response to the pause command, the interactive media application may direct the real-time media program to be stored at user equipment 40 (e.g., in storage and memory 46). In another suitable approach, the interactive media application may direct the real-time media program to be stored on a remote server. The remote server may be located at distribution facility 36, at a storage facility accessible via the Internet, or at any other suitable remote location. The real-time media program may be stored from substantially the same point in time as the issuance of the pause command and onwards. In another suitable approach, the real-time media program may begin being stored shortly after the time of issuance of the pause command. While the real-time media program is paused, the interactive media application may present information to the user.

In another suitable approach, the interactive media application may continuously store the real-time media program that the user is playing. The interactive media application may, for example, store the previous half hour or any other suitable time period of media that has been played. In this embodiment, the real-time media program being played is always retrieved from storage. The real-time media program may be played at substantially the same time at which user equipment 40 receives the real-time media program. The interactive media application in this embodiment may enable the user to rewind, pause, and fast-forward the real-time media program.

The interactive media application may also display information on user equipment 40, for example, in the form of an overlay, an interactive overlay, a program guide screen, or in any other suitable display format. The interactive media application may display information to inform the user as to the status of the interactive media application or media program, or in response to user inputs (e.g., play, pause, fast-forward, rewind, stop, etc.). This displayed information may be displayed for a certain period of time and then time out or may be removed in response to a user input (e.g., by pressing a button on user input device 56).

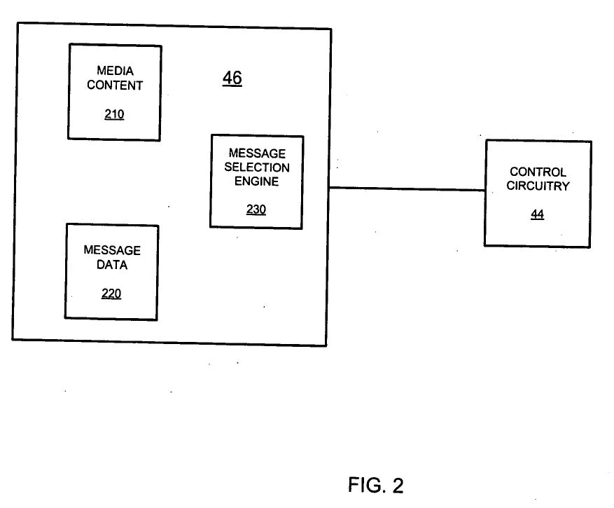

In the embodiment illustrated in FIG. 2, media content 210, which may include media programs, and associated media data may be stored in an area of the storage 46 as buffered or otherwise recorded programming received from the distribution facility 36. Similarly, message data 220, which may include media programs and media data received from the distribution facility 36 or generated by the user equipment 40, may be stored in an area of the storage 46. The message data 220 may embody, for example, text, logos and/or video clips. An interactive media application executable by the control circuitry 44 may include a message selection engine 230 that resides in the storage 46 and functions to select for display on the presentation system 52 one or more messages embodied by the message data 220. Although the media content 210, message data 220 and message selection engine 230 are illustrated in FIG. 2 and described herein as residing in and implemented by the user equipment 40, it should be understood that one or more of these features may reside in and/or be implemented by other components of the system 30, such as, for example, the server 58.

Each program associated with the media content 210 or otherwise received by the user equipment 40 may include associated media data functioning to characterize the program. For example, the media data may indicate program characteristics including, but not limited to, program topics, creator(s) of the program, commercial sponsors, broadcast channels and/or networks on which the program is carried, broadcast channels and/or networks affiliated with or otherwise related to the channel/network on which the program is carried, one or more combinations of these characteristics, or any other characteristic describing aspects of the program, distribution of the program and commercial sponsorship of the program. The media data associated with a particular program may further include trigger data operable to provoke the selection engine 230 to select for display, at a predetermined progress point of the program (e.g., two minutes prior to the program's conclusion), a message associated with the message data 220.

Each message associated with the message data 220 may similarly include associated media data functioning to enable the selection engine 230 to select for display on the presentation system 52 a message corresponding to one or more characteristics of a program displayed by the presentation system 52. For example, if a displayed program is a commercial advertisement associated with a particular brand, the selection engine 230 may select for display a logo bearing the brand. Alternatively, for example, if a particular television network carries a displayed program, the selection engine 230 may select for display a message informing the viewer of an upcoming broadcast of a different program on the network.

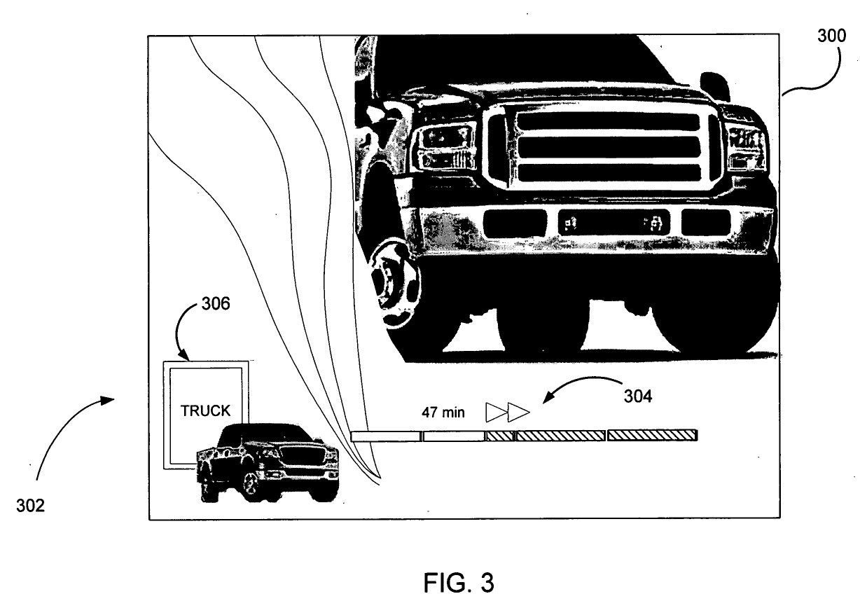

FIG. 3 is an exemplary screen display illustrating features of an embodiment of the present invention. In the illustrated embodiment, a user (not shown) of the system 30 is viewing a media program 300 on a screen 302 of the presentation system 52. During the viewing of the media program 300, the user may decide to transition to a trick-mode display of the program. For example, the program 300 may be a commercial advertisement (in the illustrated example, a commercial for a truck manufacturer), and the user may wish to skip or fast forward through the advertisement. Using the input device 56, for example, the user can issue an instruction (e.g., by pressing a “fast-forward” or other button) to accelerate through the media program 300.

In an embodiment, in response to the instruction, display of the program 300 is accelerated and a conventional progress indicator 304 is displayed overlaying the program to indicate that the program is being viewed in a fast-forward mode. Also in response to the instruction, a message 306 including subject matter corresponding to a characteristic of the program 300 is displayed in the form of a logo overlaying the program 300. In the illustrated embodiment, because the program 300 is a truck commercial, a message 306 carrying the brand of the truck manufacturer is selected for display. As such, notwithstanding the fact that the user has chosen to forego viewing the truck commercial, the system 30 functions to ensure that the branding associated with the commercial is displayed on a portion of the screen 302. Alternatively, the program 300 may be a non-commercial program topically concerning trucks or other automotive subjects, in which context also the illustrated message 306 may be appropriate for display. The message 306 may remain displayed on the screen 302 for a predetermined finite time period that may or may not correspond to the duration of trick-mode display of the program 300.

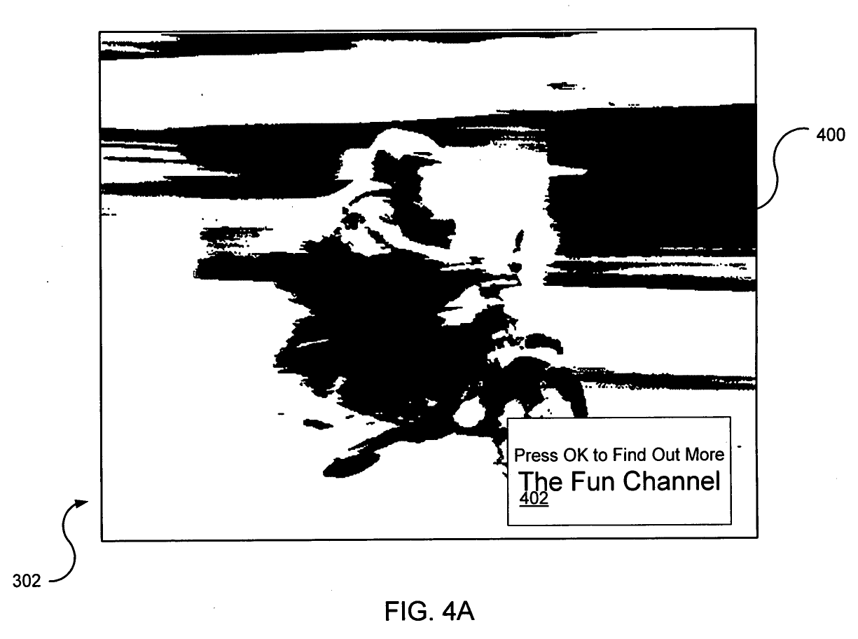

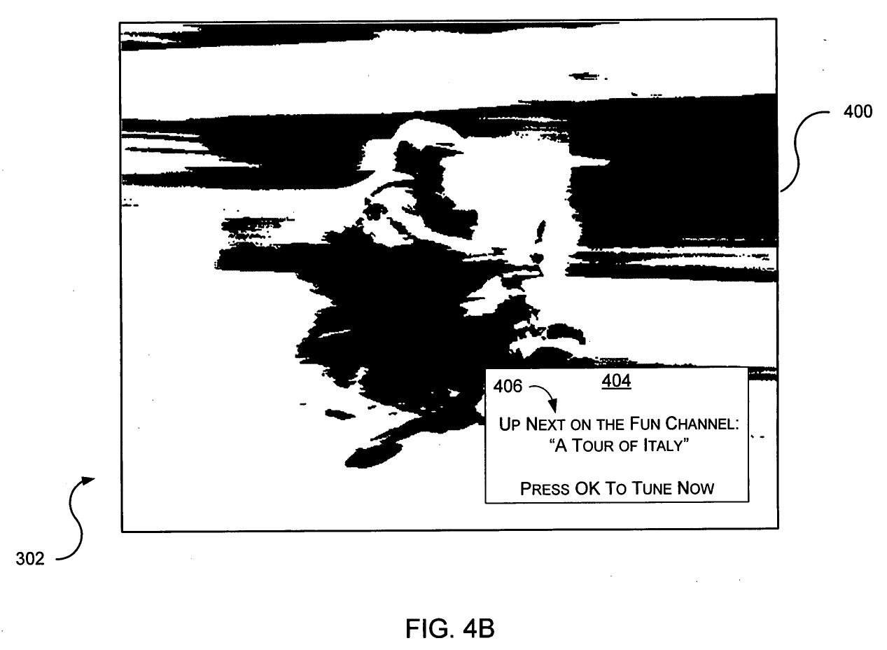

FIGS. 4A and 4B are exemplary screen displays illustrating features of an alternative embodiment of the present invention. In FIG. 4A, a user of the system 30 is viewing on the screen 302 a live broadcast of a media program 400 carried on a particular broadcast channel. Specifically, in the illustrated embodiment, the user is viewing the closing moments of the program 400. During these closing moments, a message 402 including subject matter corresponding to a characteristic of the program 400 is displayed in the form of a logo overlaying the program 400. In the illustrated embodiment, the logo represents the broadcast channel or a family of broadcast channels of which the broadcast channel is a member. The illustrated message 402 further functions to solicit from the user a request to be informed of one or more programs to be aired on the displayed channel or a related channel. The illustrated message 402 further functions as a link to informational content that the user may access by, for example, following an instruction specified by the message. For example, using the input device 56, the user may press an “OK” button to issue such an information request.

As illustrated in FIG. 4B, in response to the request, an information field 404 is displayed on a portion of the screen 302 as an overlay. In the illustrated embodiment, a message 406 displayed in the field 404 apprises the user of content available on a channel different from, but in the same channel family as, the channel on which the user is viewing the program 400. The message 406 may also provide instruction on how to access this available content.

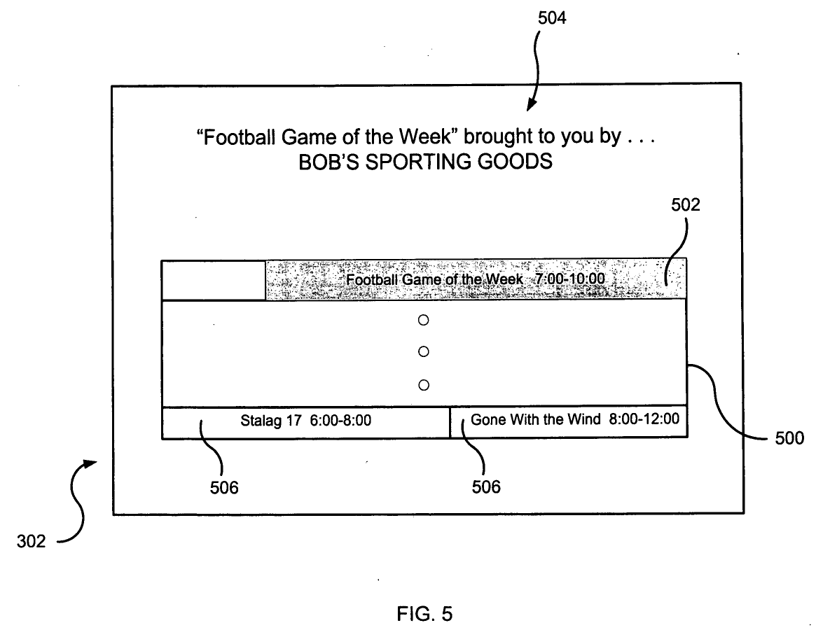

FIG. 5 is an exemplary screen display illustrating features of another alternative embodiment of the present invention. In the illustrated embodiment, a user of the system 30, using, for example, the input device 56, invokes a user interface 500, such as an electronic program guide (EPG) displayed on the screen 302, in order to browse for suitable programming. The user may navigate the interface 500 in a conventional manner using an interactive selection field, such as a cursor element. In the illustrated embodiment, the user causes the selection field to coincide, as indicated by shading, with a listing 502 displayed in the interface 500. Upon colocation of the selection field and the listing 502, a message 504 including subject matter corresponding to a characteristic of the program associated with the listing 502 is displayed on a portion of the screen 302. In the illustrated embodiment, the message 504 functions to identify a commercial sponsor of the program associated with the listing. If, for example, the user moves the selection field to another listing 506, the message 504 may be supplanted by a different displayed message (not shown) related to the program associated with the listing 506.

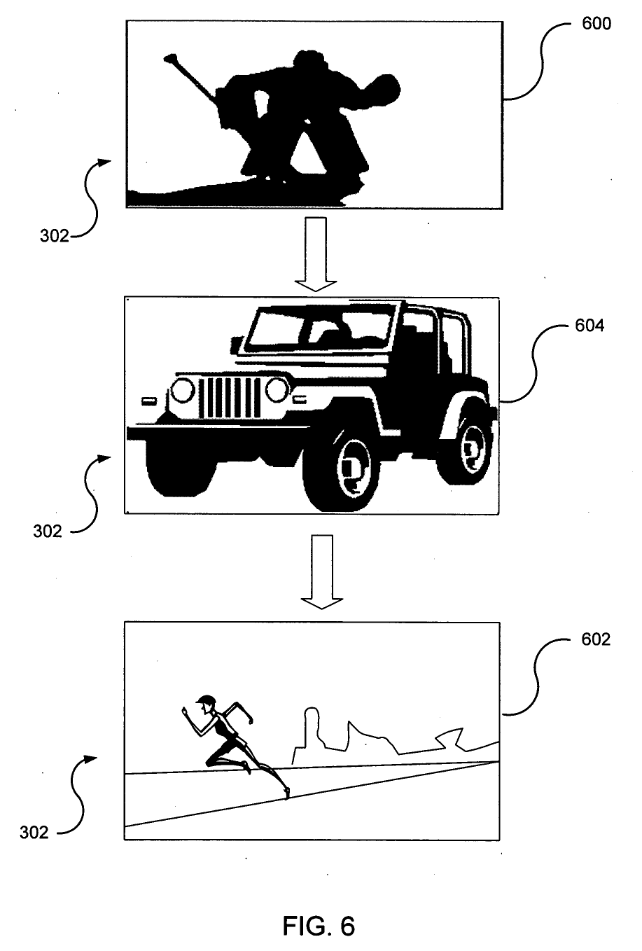

FIG. 6 illustrates exemplary screen displays showing features of another alternative embodiment of the present invention. In the illustrated embodiment, a user of the system 30 is viewing a first media program 600 on the screen 302. Using the input device 56, for example, the user issues a command to transition away from display of the first program 600 to display of a second program 602. In response to this command, a video clip 604 of finite duration (e.g., 3-5 seconds in length) that may include, for example, a commercial advertisement is displayed on at least a portion of the screen 302. The video clip 604 may or may not include subject matter corresponding to a characteristic of one or more of the programs 600, 602. At the conclusion of the video clip 604, the second program 602 is displayed on the screen 302. Alternatively, the video clip 604 may be displayed concurrently with the first program 600 (e.g., in picture-in-picture mode) prior to transition to the second program 602, or the video clip 604 may be displayed concurrently with the second program upon transition thereto.

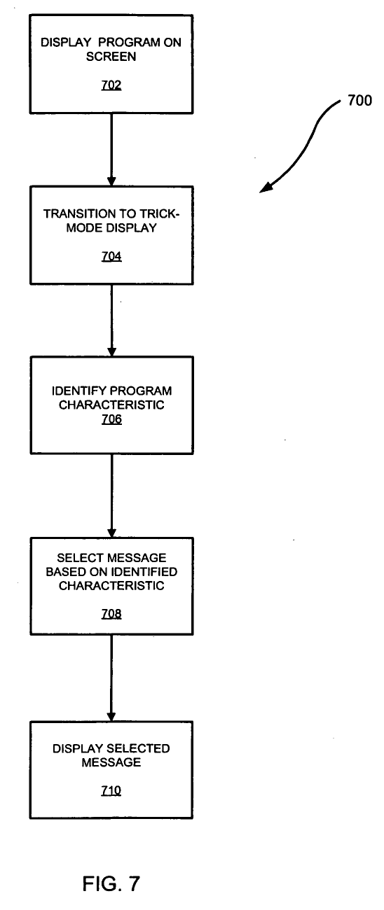

FIG. 7 illustrates a process 700 according to an embodiment of the invention. The process 700 is illustrated as a set of operations shown as discrete blocks. The process 700 may be implemented in any suitable hardware, software, firmware, or combination thereof. The order in which the operations are described is not to be necessarily construed as a limitation.

At a block 702, the system 30 displays on the screen 302 a first video program having associated therewith a characteristic. The first program may include media content 210 buffered or otherwise stored in the storage 46 or elsewhere in the system 30. As elsewhere discussed herein, the characteristic may be, for example, a program topic, commercial sponsor, including branded content, or broadcast channel on which the first program is carried, as indicated by media data associated with the first program.

At a block 704, the system 30 transitions to a trick-mode display of the first program. For example, the communications circuitry 48 may receive a trick-mode command signal from the input device 56. Depending on the type and/or location of the first program, this signal may be relayed or otherwise transmitted in appropriate form to the media distribution facility 36 and main facility 34 as a request to display the first program in a trick mode. The trick-mode display may be one of, for example, chapter-skip, instant-replay, pause, fast-forward, skip, slow-motion and rewind display.

At a block 706, the system 30 identifies the characteristic associated with the first program. For example, the control circuitry 44 may identify the characteristic by analyzing media data stored in the storage 46 or otherwise associated with the first program.

At a block 708, the selection engine 230, based on the identified characteristic, selects a message. For example, the selection engine 230 may receive from the control circuitry 44 an indication of the identified characteristic. The selection engine 230 then analyzes the message data 220 stored in the storage 46 or elsewhere in the system 30 to identify and select a message, the subject matter of which corresponds to the identified characteristic. The subject matter may identify, for example, a second program carried on the broadcast channel on which the first program is carried, a commercial sponsor, including associated branded content, of the first program, the creator of the first program, or subject matter topically related to the subject matter associated with the first program.

At a block 710, the system 30, in response to the trick-mode display of the first program, causes the message to be displayed on the screen 302.

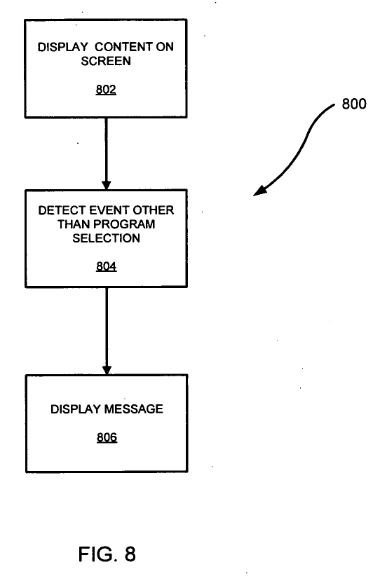

FIG. 8 illustrates a process 800 according to an embodiment of the invention. The process 800 is illustrated as a set of operations shown as discrete blocks. The process 800 may be implemented in any suitable hardware, software, firmware, or combination thereof. The order in which the operations are described is not to be necessarily construed as a limitation.

At a block 802, the system 30 displays on the screen 302 first content having associated therewith a characteristic. For example, the content may include a live-broadcast or stored video program or commercial advertisement. As such, the characteristic may include a first broadcast television channel on which the program or advertisement is carried. Alternatively, the content may include information pertaining to a service, such as, for example, an electronic-messaging or email service, offered via the system 30. For example, the content may include a notification to the user of a news headline or sports score of particular interest to the user. The characteristic may thus include an indication of a commercial provider of the service, such as, for example, a news- or sports-media entity. Alternatively still, the content may include an EPG listing. The characteristic may thus include the program associated with the listing and offered via the system 30.

At a block 804, the system 30 detects an event other than selection (i.e., tuning or otherwise invoking presentation) of a program by a user. For example, the event may consist of a user causing an EPG listing to coincide on the screen 302 with an interactive selection field. Alternatively, the event may include a determination that the first content has reached a predetermined progress point.

At a block 806, the system 30, in response to the event, causes to be displayed on the screen 302 a promotional message comprising subject matter corresponding to the characteristic and intended to influence the user to consume (i.e., view, buy, etc.) a product, service or content other than the first content. The promotional message may be selected from storage in the user equipment 40, distribution facility 36, or database 32 by one or more components of the system 30. The promotional message may include a link, selectable by the user, to displayable second content. If, for example, the characteristic includes a first broadcast television channel on which a program or advertisement is carried, the subject matter may include an identification of second content carried on a second broadcast channel related to the first channel. If, for example, the characteristic includes an indication of a commercial provider of a service offered via the system 30, the subject matter may include an identification, such as that associated with a branded logo, of the commercial provider. If, for example, the characteristic includes a program associated with an EPG listing, the subject matter may include an identification, such as a branded logo, of a commercial sponsor of the program.

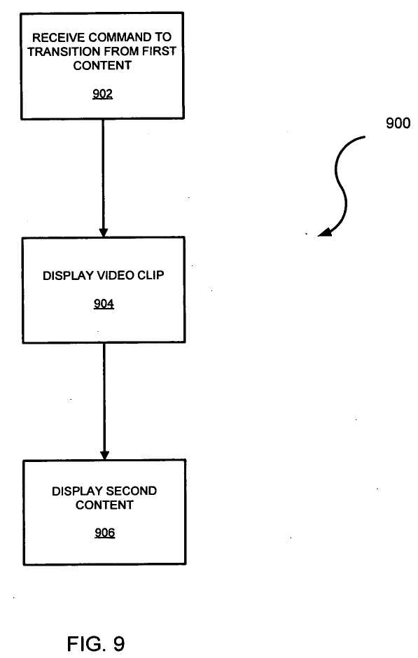

FIG. 9 illustrates a process 900 according to an embodiment of the invention. The process 900 is illustrated as a set of operations shown as discrete blocks. The process 900 may be implemented in any suitable hardware, software, firmware, or combination thereof. The order in which the operations are described is not to be necessarily construed as a limitation.

At a block 902, the system 30 receives a command to transition from display of first content on the screen 302 to display of second content on the screen.

At a block 904, the system 30, in response to the command, displays on the screen 302 a video clip. In an embodiment, the system 30 transitions from full-screen display of the first content to full-screen display of the video clip. The video clip may be selected from storage in the user equipment 40, distribution facility 36, or database 32 by components of the system 30.

At a block 906, the system 30 causes the second content to be displayed on the screen 302.

Embodiments within the scope of the present invention also include computer-readable media for carrying or having computer-executable instructions or data structures stored thereon. Such computer-readable media can be any available media that is accessible by a general-purpose or special-purpose computer or other electronic device. By way of example, and not limitation, such computer-readable media can include physical storage media such as RAM, ROM, EEPROM, CD-ROM or other optical disk storage, magnetic disk storage or other magnetic storage devices, or any other medium that can carry or store program code means. When information is transferred or provided over a network or another communications connection (either hardwired, wireless, or a combination of hardwired or wireless) to an electronic device, the electronic device properly views the connection as a computer-readable medium. Thus, such a connection is also properly termed a computer-readable medium. Consequently, combinations of the above should also be included within the scope of computer-readable media.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. In a system coupled to a display device having a screen, a method comprising:
displaying on the screen a first video program having associated therewith a characteristic;
transitioning to a trick-mode display of the first program; and
in response to transitioning to the trick-mode display, displaying on the screen a message comprising subject matter corresponding to the characteristic.

2. The method of claim 1 wherein the characteristic comprises a broadcast television channel on which the first program is carried.

3. The method of claim 2, wherein the subject matter identifies a second video program carried on the broadcast television channel.

4. The method of claim 1 wherein the characteristic comprises branded content.

5. The method of claim 4 wherein the subject matter comprises the branded content.

6. The method of claim 1 wherein displaying the message further comprises:
identifying the characteristic; and
selecting the message based on the identified characteristic.

7. The method of claim 1 wherein the trick-mode display comprises one of pause, fast-forward, skip, slow-motion and rewind display.

8. In a system that includes a content distribution facility coupled to at least one client device for presenting programming via a presentation device having a screen, a method, comprising:
displaying on the screen first content having associated therewith a characteristic; and
displaying, in response to an event other than user selection of a program, a promotional message stored in at least one of the distribution facility and client device and comprising subject matter corresponding to the characteristic.

9. The method of claim 8 wherein:
the first content comprises information pertaining to a service associated with the system; and
the characteristic comprises a commercial provider of the service.

10. The method of claim 9 wherein the subject matter comprises an identification of the commercial provider.

11. The method of claim 8 wherein:
the first content comprises an electronic-program-guide listing; and
the event comprises a user causing the listing to coincide on the screen with an interactive field.

12. The method of claim 11 wherein the characteristic comprises a program corresponding to the listing.

13. The method of claim 12 wherein the subject matter comprises an indicator of a commercial sponsor of the program.

14. The method of claim 8 wherein the characteristic comprises a first broadcast television channel on which the first content is carried.

15. The method of claim 14 wherein the subject matter identifies second content carried on a second broadcast television channel related to the first channel.

16. The method of claim 8 wherein the event comprises determining that the first content has reached a predetermined progress point of the first content.

17. The method of claim 8 wherein the message comprises a selectable link to displayable second content.

18. A computer-readable medium having stored therein executable instructions operable to cause the system to perform the method of claim 8.

19. In a system that includes a content distribution facility coupled to at least one client device for presenting content via a display device having a screen, a method, comprising:
receiving a command to transition from display of first content on the screen to display of second content on the screen;
in response to receiving the command, displaying on at least a first area of the screen a video clip stored in at least one of the distribution facility and client device; and
displaying the second content.

20. The method of claim 19 wherein displaying the video clip comprises transitioning from full-screen display of the first content to full-screen display of the video clip.
